(19) United States
(12) Patent Application Publication
(10) Pub. No.: US 2025/0392830 A1
(43) Pub. Date: Dec. 25, 2025

(54) IMAGING APPARATUS, PROCESSING METHOD, AND STORAGE MEDIUM

(71) Applicant: CANON KABUSHIKI KAISHA, Tokyo (JP)

(72) Inventors: SHIGEHARU AOKI, Kanagawa (JP); NAOKI ISHIKAWA, Chiba (JP)

(21) Appl. No.: 19/234,456

(22) Filed: Jun. 11, 2025

(30) Foreign Application Priority Data
Jun. 19, 2024 (JP) 2024-099067

(51) Int. Cl. H04N 23/84; H04N 25/13; H04N 25/59

(52) U.S. Cl. CPC H04N 23/843; H04N 25/59; H04N 25/134

(57) ABSTRACT

An imaging apparatus comprising: an imaging element having a plurality of pixels each including a photoelectric conversion unit, a first charge holding portion for holding an output of the photoelectric conversion unit, and a second charge holding portion for holding an output of the photoelectric conversion unit, and a defective pixel correction unit configured to calculate an interpolation pixel value for interpolating a pixel value from the first charge holding portion based on a pixel value output from the second charge holding portion of the pixel in a case in which a defect is present in the first charge holding portion of a predetermined pixel.

### BACKGROUND OF THE DISCLOSURE

### Field of Technology

The present disclosure relates to an imaging apparatus, a processing method, a storage medium, and the like.

### Description of the Related Art

A GS sensor has a global shutter (hereinafter, referred to as “GS”) function by incorporating a charge holding portion in each pixel. The pixel of this GS sensor is provided with a gate that transfers the signal charges accumulated in the photoelectric conversion unit to the charge holding portion.

In the GS sensor, the GS function is realized by simultaneously performing transfer from the photoelectric conversion units to the charge holding portions for all pixels, and making the timing of the start and the end of charge accumulation in the photoelectric conversion units the same for all pixels.

Additionally, U.S. Patent Application Publication No. 2013/0135486 describes a configuration in which a plurality of charge holding portions are provided for a single photoelectric conversion unit, and charges are transferred to each charge holding portion multiple times during one frame period. Thereby, it is possible to acquire a plurality of images having different total charge accumulation times for transferring to each charge holding portion. Then, a dynamic range can be improved by combining the plurality of obtained images.

In contrast, in an imaging element used for a CMOS sensor, defects may occur during the manufacturing process and the like. For example, when a defect is present in the charge holding portion, electron leakage into the charge holding portion occurs depending on the time the charge is held in the charge holding portion and the like, and as a result, a signal in which the leaked electrons are added to the charge accumulated in the charge accumulation unit is output. Consequently, the output level becomes higher than the output level of other normal pixels, thereby causing deterioration in image quality.

Therefore, if a defect is present in the charge holding portion used for long accumulation in the GS sensor of U.S. patent application publication No. 2013/0135486, a signal difference corresponding to the accumulation time ratio with respect to the signal of the charge holding portion used for short accumulation is produced. Accordingly, the signal of the charge holding portion accumulated for a long time due to the defect produces an excessive output. Consequently, when the image signals for the long accumulation and short accumulation are combined, the defect remains. In contrast, in Japanese Patent Application Laid-Open No. 2012-044452, a defective pixel is corrected by an interpolated value calculated from surrounding pixels.

However, in the technology disclosed in Japanese Patent Application Laid-Open No. 2012-044452, interpolation processing using signals from surrounding pixels is performed on a pixel where a defect occurs, regardless of occurrence location of the defect. Consequently, in a subject having high contrast and/or high spatial frequency, an accurate interpolation pixel value cannot be generated from the surrounding pixels, and correction artifacts may remain, resulting in image quality deterioration.

### SUMMARY OF THE DISCLOSURE

An imaging apparatus according to one aspect of the present disclosure comprising: an imaging element having a plurality of pixels each including a photoelectric conversion unit, a first charge holding portion for holding an output of the photoelectric conversion unit, and a second charge holding portion for holding an output of the photoelectric conversion unit, and a defective pixel correction unit configured to calculate an interpolation pixel value for interpolating a pixel value from the first charge holding portion based on a pixel value output from the second charge holding portion of the pixel in a case in which a defect is present in the first charge holding portion of a predetermined pixel.

Further features of the present disclosure will become apparent from the following description of embodiments with reference to the attached drawings.

### BRIEF DESCRIPTION OF THE DRAWINGS

FIG. 1 is a block diagram illustrating a schematic configuration example of an imaging element 100 according to the first embodiment.

FIG. 2 is a functional block diagram illustrating a configuration example of an imaging apparatus 200 according to the first embodiment.

FIG. 3 is an equivalent circuit diagram of each photoelectric conversion pixel of the imaging apparatus according to the first embodiment.

FIGS. 4A and FIG. 4B are diagrams explaining an example of defective pixel correction in the first embodiment.

FIG. 5 is an explanatory view showing an example of a charge amount transition in defective pixel correction in the first embodiment.

FIG. 6 is an explanatory view showing an example of a charge amount transition in defective pixel correction in the second embodiment.

FIG. 7 is an explanatory view showing another example of a charge amount transition in defective pixel correction in the second embodiment.

FIG. 8 is an equivalent circuit diagram of an imaging apparatus according to the third embodiment.

FIG. 9 is a schematic diagram of a cross-section of each pixel of the imaging apparatus according to the third embodiment.

FIGS. 10A and 10B are explanatory views showing an example of defective pixel correction in the third embodiment.

FIGS. 11A and 11B are explanatory views showing an example of pixel correction in a case in which a charge holding portion has a defect in the fourth embodiment.

FIG. 12 is an equivalent circuit diagram of the imaging apparatus according to the fourth embodiment.

FIGS. 13A and 13B are explanatory views showing an example of pixel correction in a case in which a defect is present in an FD according to the fifth embodiment.

FIG. 14 is a flowchart explaining an example of a processing method according to the sixth embodiment.

FIG. 15 is a flowchart explaining an example of correction processing in a case in which a defect is present in the charge holding portion in the sixth embodiment.

FIG. 16 is a flowchart illustrating an example of correction processing in a case in which a defect is present in the FD region in the sixth embodiment.

FIGS. 17A and 17B are diagrams for explaining an example of defective pixel correction in the seventh embodiment.

FIGS. 18A and 18B are diagrams for explaining an example of defective pixel correction in the eighth embodiment.

FIGS. 19A and 19B are diagrams for explaining an example of defective pixel correction in the ninth embodiment.

FIG. 20 is a flowchart illustrating an example of a processing method according to the tenth embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

In the following embodiments, a signal carrier is an electron, a signal accumulation layer is an N-type semiconductor, and a transistor forming a circuit is an N-type MOS transistor unless otherwise specified. However, the present disclosure is not limited thereto, and a hole may be used as a signal carrier, wherein a P-type carrier is used instead of an N-type carrier.

Additionally, in the following embodiments, an example in which a GS sensor is used as an imaging apparatus will be explained. Additionally, each pixel (each photoelectric conversion pixel) in the embodiments includes a photoelectric conversion unit, a charge holding portion, a photoelectric conversion unit charge transfer MOS transistor for transferring a signal charge of the photoelectric conversion unit to the charge holding portion, and an amplification MOS transistor for amplifying the signal charge and outputting the amplified signal charge. Additionally, each pixel has a charge holding portion charge transfer MOS transistor for transferring a signal charge of a memory to the amplification MOS transistor.

### First Embodiment

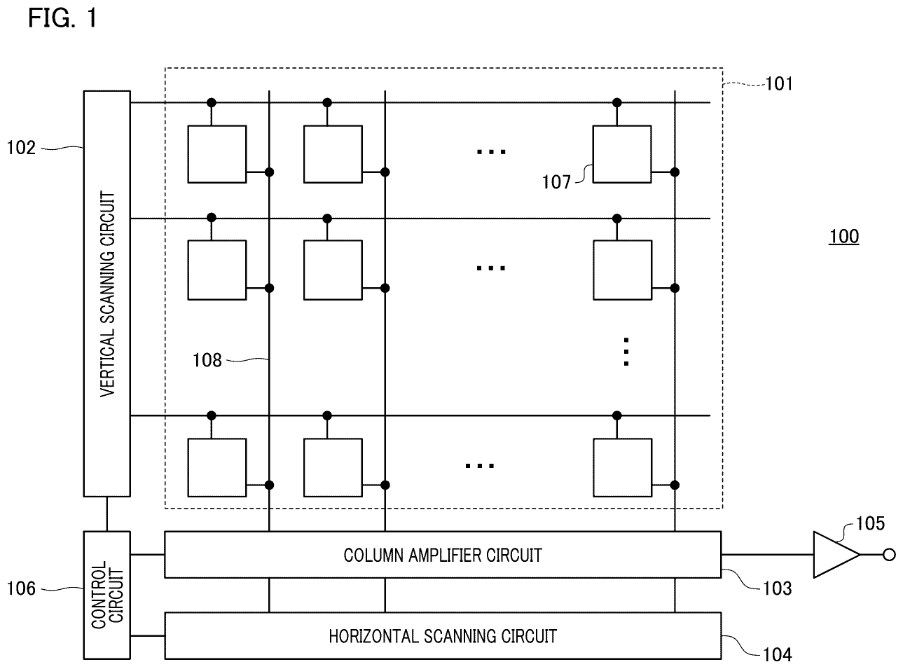

FIG. 1 is a block diagram illustrating a schematic configuration of an imaging element 100 according to the first embodiment. The imaging element 100 is provided with a pixel unit 101, a vertical scanning circuit 102, a column amplifier circuit 103, a horizontal scanning circuit 104, an output circuit 105, a control circuit 106, and the like.

The pixel unit 101 includes a plurality of pixels (photoelectric conversion pixels) 107 arranged in a two-dimensional array, including a plurality of rows and columns. That is, the imaging element 100 has a plurality of pixels (photoelectric conversion pixels) 107. The vertical scanning circuit 102 supplies a control signal to a plurality of transistors included in the pixel 107 and controls ON (conductive state) or OFF (non-conductive state) of these transistors.

A column signal line 108 is provided for each column of the pixels 107 and the signals from the pixel 107 are read out to the column signal line 108 for each column. The column amplifier circuit 103 is provided with an amplifier for amplifying a pixel signal output to the column signal line 108, and an AD conversion circuit that performs analog-to-digital conversion on the signal. The horizontal scanning circuit 104 supplies a control signal to a switch connected to an amplifier in the column amplifier circuit 103, and controls the switch to be ON or OFF.

The control circuit 106 controls the vertical scanning circuit 102, the column amplifier circuit 103, and the horizontal scanning circuit 104. The output circuit 105 is provided with a buffer amplifier, a differential amplifier, and other components, and outputs the pixel signal from the column amplifier circuit 103 to a signal processing unit outside the imaging element.

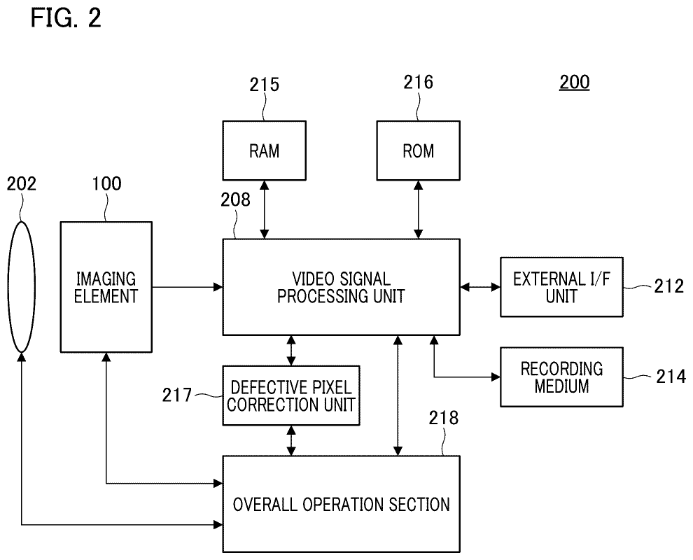

FIG. 2 is a functional block diagram illustrating a configuration example of an imaging apparatus 200 according to the first embodiment. Note that some of the functional blocks shown in FIG. 2 are realized by causing a CPU and the like, which serve as a computer included in the imaging apparatus, to execute a computer program stored in a memory that acts as a storage medium.

However, a part or all of the functional blocks may be realized by hardware. As hardware, a dedicated circuit (ASIC), a processor (such as a reconfigurable processor and DSP), and the like can be used. Additionally, each functional block shown in FIG. 2 may not be incorporated into the same housing and may instead be configured by separate devices connected to each other via a signal path.

The imaging apparatus 200 shown in FIG. 2 is provided with the imaging element 100, a lens 202 that forms an optical image of a subject on the light-receiving unit of the imaging element, and a signal processing unit 208 that performs the processing on the signal output from the imaging element.

The signal processing unit 208 generates image data from the digital signal output by the imaging element 100, and outputs image data by performing various corrections and compression, and the like, as necessary. Furthermore, the signal processing unit 208 also functions as a combining processing unit that combines signals read out from the imaging element and generates a high dynamic range image. However, the combining processing described above may be performed outside the imaging apparatus.

The imaging apparatus 200 is further provided with a RAM 215, a ROM 216, an external interface unit (external I/F unit) 212 for communicating with an external computer, and the like, and a recording medium 214 comprised of a semiconductor memory, and the like, for performing recording and reading of image data.

Reference numeral 218 denotes an overall operation section that controls the entire imaging apparatus 200, and includes a CPU that acts as a computer. The RAM 215 temporarily stores calculation results and output signals from the signal processing unit, and the ROM 216 stores defective pixel data, various adjustment values, and the like, wherein the defective pixel data includes the position, level, and type of defect of the corresponding pixels. Additionally, a computer program to be executed by the CPU is stored in the ROM 216.

Additionally, the imaging apparatus 200 is provided with a defective pixel correction unit 217 for correcting the pixel values of defective pixels stored in the ROM 216. Details of the defective pixel correction unit 217 will be described below.

Note that in the present embodiment, defective pixels are stored in the ROM 216 in advance. However, a configuration may be adopted in which a defective pixel detection block is separately provided to detect a defective pixel and generate a defective pixel data, or a defective pixel data stored in the ROM 216 is updated using detection results by the defective pixel detection block.

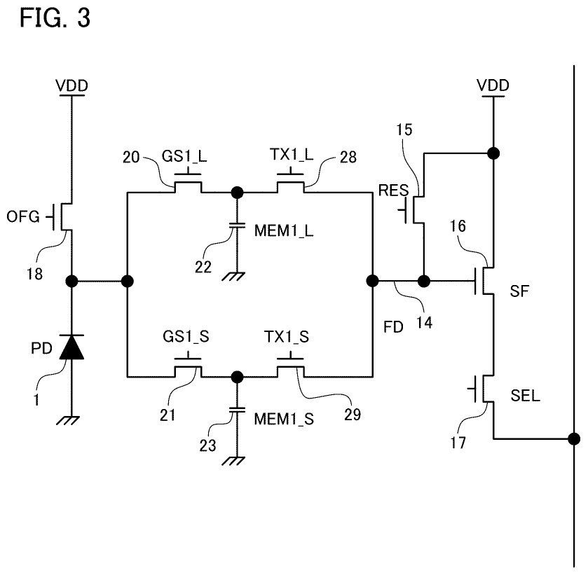

FIG. 3 is an equivalent circuit diagram of each photoelectric conversion pixel of the imaging element according to the first embodiment. PD1 represents a photodiode as an example of the photoelectric conversion unit. GS1_L20 and GS1_S21 are charge transfer units, and are configured to be capable of transferring signal charges generated in the photoelectric conversion unit PD 1 to a subsequent circuit element. Additionally, MEM1_L22 and MEM1_S23 represent charge holding portions, and are each configured to be able to hold signal charges generated by the photoelectric conversion unit.

Here, MEM1_L22 functions as a first charge holding portion for holding the output of the photoelectric conversion unit, and MEM1_S23 functions as a second charge holding portion for holding the output of the photoelectric conversion unit. Additionally, in the present embodiment, charges accumulated in the photoelectric conversion unit during the first exposure time are held in the first charge holding portion, and charges accumulated in the photoelectric conversion unit for a second exposure time shorter than the first exposure time are held in the second charge holding portion.

Additionally, GS1_L20 functions as a first charge transfer unit that transfers charges from the photoelectric conversion unit to the first charge holding portion, while GS1_S21 functions as a second charge transfer unit that transfers charges from the photoelectric conversion unit to the second charge holding portion.

TX1_L28 and TX1_S29 are transfer units, each of which can transfer the signal charge held by the charge holding portion in the preceding stage to the circuit element in the subsequent stage.

The FD 14 is, for example, a floating diffusion region disposed on a semiconductor substrate, is capable of holding signal charges transferred via a transfer unit from the preceding stage charge holding portion, and is an input node of a subsequent SF 16. That is, charges from the first charge holding portion and the second charge holding portion are transferred to the floating diffusion part.

RES 15 is a reset unit that can supply a reference voltage to the input node FD 14 of the amplification unit. SF 16 is an amplification unit such as, for example, a source follower circuit using a MOS transistor, and reads out to the outside by amplifying a signal based on a signal charge transferred to FD 14.

In the SF16, a gate of the MOS transistor and FD 14 are electrically connected. In the figure, a plurality of transfer units, TX1_L 28 and TX1_S 29, share the input node FD 14 and the amplification unit SF 16, although the circuit configuration may be without sharing.

A SEL 17 is a selection unit, and is selected by a selection signal from the vertical scanning circuit 102 and can read out signals externally for each pixel or for each pixel row. OFG 18 represents a charge discharge control unit capable of discharging the signal charge of the photoelectric conversion unit PD1. For example, a MOS transistor can be used as the charge discharge control unit.

In the present embodiment, a configuration is adopted in which a semiconductor region having the same polarity as that of the signal charge, which constitutes part of the photoelectric conversion unit, is used as the source, and a semiconductor region (overflow drain region: OFD region) to which a power source voltage VDD19 is supplied is a drain. Additionally, each of the transfer unit, the reset unit, the selection unit, and the charge-discharge control unit can use a MOS transistor.

When the charge transfer unit GS1_L20 is turned on, the signal charge generated by the photoelectric conversion unit PD1 is transferred to the charge holding portion MEM1_L22. When the charge transfer unit GS1_S21 is turned on, the signal charge generated by the photoelectric conversion unit PD1 is transferred to the charge holding portion MEM1_S23.

Note that one of GS1_L20 and GS1_S21 may be turned on during photoelectric conversion in PD1. That is, during photoelectric conversion during long exposure (long duration) in PD1, GS1_L20 may be turned on, and GS1_S21 may be turned off. Conversely, during photoelectric conversion during short exposure (short duration) in PD1, GS1_L20 may be turned off, and GS1_S21 may be turned on.

When the charge transfer unit TX1_L28 is turned on, the signal charge held in the charge holding portion MEM1_L22 is transferred to FD14. When the charge transfer unit TX1_S29 is turned on, the signal charge held in the charge holding portion MEM1_S23 is transferred to FD14.

Thus, by providing two charge accumulation portions for accumulating transferred signal charges for one photoelectric conversion unit PD1, charges accumulated for a long time and charges accumulated for a short duration can be stored in the respective charge accumulation units. Therefore, an image having a high dynamic range can be acquired by combining signals based on both charges later, according to the luminance level.

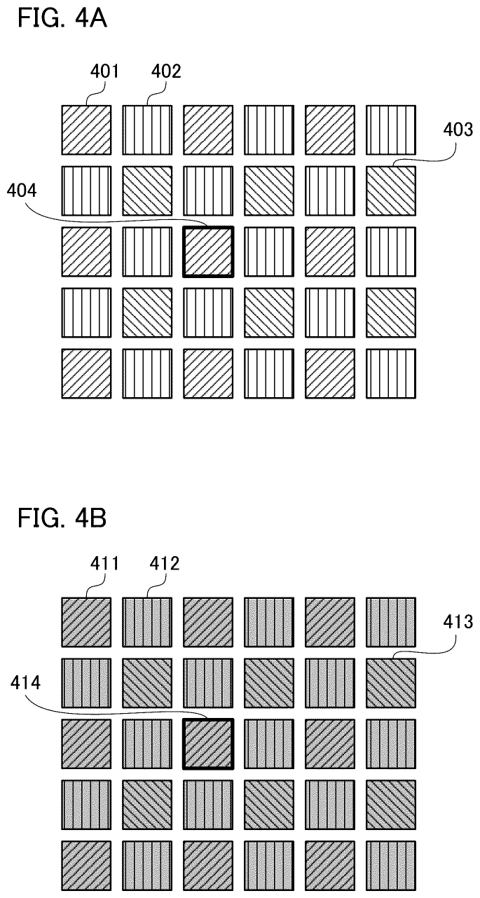

FIG. 4A and FIG. 4B are explanatory views showing an example of defective pixel correction in the first embodiment, illustrating an image plane output from the imaging element. FIG. 4A shows the image plane of a long exposure image (an image corresponding to charges accumulated for a long time) accumulated in the charge holding portion MEM1_L22 in FIG. 3.

FIG. 4B shows the image plane of a short-exposure image (an image corresponding to charges accumulated for a short duration) accumulated in the charge holding portion MEM1_S23 in FIG. 3. FIG. 4 shows, as an example, an output image of a GS sensor having color filters in a Bayer array, where 401 and 411 are R (red) pixels, 402 and 412 are G (green) pixels, and 403 and 413 are B (blue) pixels. However, other color filter arrays may also be used.

Note that a Bayer array refers to a color filter array, in a case in which, for example, with three colors of filters R, G, and B, color filters of R, G, R, G, and so on, are arranged for pixels of a predetermined row, and color filters of G, B, G, B, and so on, are arranged for the adjacent row.

Reference numeral 404 denotes a defective pixel, and in the present embodiment, it is assumed that, for example, a defect is present in a charge holding portion within the pixel. In this case, for example, in the long-exposure image, defective pixel correction can be performed by generating an interpolation pixel value for the defective pixel 404 based on output values (reference pixel values) of surrounding pixels of the same color in the same image plane, and replacing the output value of the defective pixel 404 with the interpolation pixel value.

However, in a subject having high contrast and/or spatial frequency, the variation in the reference pixel value is large, and the interpolation pixel value may not be correctly generated. In such a case, correction artifacts may occur, resulting in degraded image quality.

In the present embodiment, instead of calculating an interpolation pixel value from surrounding pixels, or in addition to such calculation, defective pixel correction is performed by calculating an interpolation pixel value using pixel values output from the same PD through different paths, thereby performing favorable defective pixel correction. As a more specific example, a case in which the charge holding portion MEM1_L22 of the defective pixel 404 is defective will be described below.

Although the defective pixel 404 in FIG. 4A and the pixel 414 in FIG. 4B are both pixel signals output from the same PD, the output paths are different. That is, the pixel value of the defective pixel 404 is accumulated in the charge holding portion MEM1_L22 and output via the FD14, whereas the pixel value of the pixel 414 is a pixel value output via FD 14 accumulated in the charge holding portion MEM1_S 23.

Although the defect pixel 404 becomes a defect pixel due to the influence of a defect in the charge holding portion MEM1_L 22, for example, the short-second image does not use the charge holding portion MEM1_L 22, so the short-second image is not affected by the defect and a normal output pixel value can be obtained. Therefore, in the present embodiment, an interpolation pixel value for the defect pixel 404 is generated by using the pixel value of the pixel 414.

If no defect is present, the pixel value of the defective pixel 404 corresponds to the charge accumulated in the photoelectric conversion unit PD1 during the long exposure (photoelectric conversion time). Additionally, the pixel value of pixel 414 corresponds to the charge accumulated during accumulation time during short exposure (photoelectric conversion time) in the same photoelectric conversion unit PD1.

Note that the same applies to the case in which GS1_L20 is turned on and GS1_S21 is turned off during photoelectric conversion during long exposure (long duration) in PD1, and GS1_L20 is turned off while GS1_S21 is turned on during photoelectric conversion during short exposure (short duration). However, in such a case, the charge holding portion becomes more susceptible to the influence of a defect.

That is, originally, the pixel value of the defective pixel 404 and the pixel value of the pixel 414 become signals different from each other by an accumulation time (photoelectric conversion time) ratio in the photoelectric conversion unit PD1. Note that in the explanation of the present embodiment, the terms accumulation time, photoelectric conversion time, and exposure time are used interchangeably.

Accordingly, the corrected pixel value of the defect pixel 404 can be obtained as the pixel value of pixel 414 multiplied by (the accumulation time during long exposure in the photoelectric conversion unit PD1 (first exposure time)/the accumulation time during short exposure in the photoelectric conversion unit PD1 (second exposure time)). That is, the defective pixel correction unit 217 calculates the interpolation pixel value based on the pixel value read out from the second charge holding portion, according to the ratio between the first exposure time and the second exposure time.

Thus, the defective pixel value can be generated without being affected by the surrounding pixels by calculating the interpolation pixel value using the pixel values output from the same PD through different paths. In particular, favorable defective pixel correction is possible in a subject having high contrast and/or spatial frequency. Therefore, according to the present embodiment, an imaging apparatus can be obtained that enables defect correction with minimal influence from the subject, even in a case in which a defect is present in a pixel.

Note that in the video signal processing unit of the imaging apparatus in the present embodiment, as described above, signal charges accumulated in a plurality of charge holding portions having different exposure times (photoelectric conversion times) are accumulated, a long-exposure image and a short-exposure image are output, and these images are combined to generate an image having a high dynamic range. Therefore, in the present embodiment, defective pixel correction process, using pixel values output through different paths, is performed by the defective pixel correction unit before the combining process of combining the long-exposure image and the short-exposure image.

### Second Embodiment

In the first embodiment, it was shown that favorable defect pixel correction is possible by performing correction using a pixel signal of a different path connected to a common photoelectric conversion unit, whereby an interpolation pixel value can be generated without being affected by surrounding pixels, particularly for a subject having high contrast and high spatial frequency. In the second embodiment, the relation between the combining process for obtaining a high dynamic range and the interpolation process for defective pixels will be described.

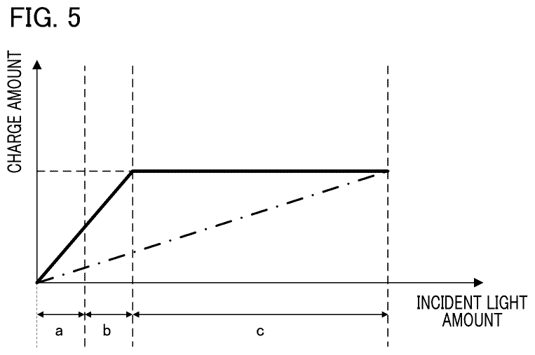

First, a case in which a defect is present in a long-exposure image will be described. FIG. 5 is an explanatory view showing an example of charge amount transition in the defective pixel correction of the first embodiment and is a graph showing that the horizontal axis represents the incident light amount (luminance) and the vertical axis represents the charge amount. The solid line indicates the amount of charge accumulated in the charge holding portion for a long exposure, while the dashed- dotted line indicates the amount of charge accumulated for a short exposure.

FIG. 5 shows that the charge amount increases in proportion to the incident light amount, wherein the gradient of this proportional relationship corresponds to the accumulation time. For example, in a case in which the incident light amount is the same, if the accumulation time is doubled, the charge accumulated in the charge holding portion becomes doubled.

In FIG. 5, regions a, b, and c are used to divide each range of incident light for convenience. “a” represents a low-luminance region in which the incident light amount is small, “c” represents a high-luminance region in which the incident light amount is large, and “b” represents an intermediate-luminance region.

First, focusing on the long-exposure image, saturation does not occur in the low-luminance region a and the intermediate-luminance region b, as a result, an effective pixel signal can be obtained. In the high-luminance region c, a large amount of charge becomes saturated, and the pixel signal at this time enters what is referred to as a “highlight-detail loss state”.

Since the short-exposure image is not saturated even in the high-luminance region c, an image having a high dynamic range can be obtained by combining the images such that the short-exposure image is used in the high-luminance region c and the long-exposure image is used in the low-luminance region a. This is an example of HDR composition.

Here, although it has been described that the long-exposure image and the short-exposure image are switched at the point at which the long-exposure image becomes saturated, for example, in the intermediate-luminance region b, the pixel signal of the long-exposure image and the pixel signal of the short-exposure image may also be weighted and added according to the amount of incident light.

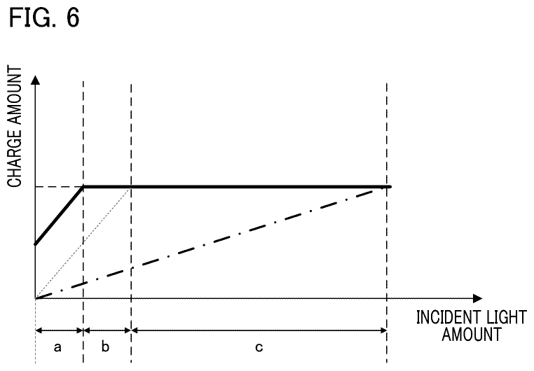

FIG. 6 is an explanatory view showing an example of charge amount transition in defective pixel correction of the second embodiment, and illustrates the charge amount in relation to the incident light amount in the case in which a defect is present in the charge holding portion used for obtaining a long-exposure image. In contrast to FIG. 5, the amount of charge in the long-exposure image is offset, for example, due to a defect in the charge holding portion.

Similarly to the above, the regions are divided into regions a, b, and c according to the amount of incident light. Since region a represents a low-luminance region and the long-exposure image is preferentially used in HDR composition, the output signal in this region is affected by the defect.

That is, region a is a region in which defective pixel correction is necessary. In the intermediate-luminance region b, saturation occurs by adding an offset due to the defect to the original pixel signal. At this time, although the long-exposure image is saturated, the short-exposure image is preferentially used.

Therefore, although a defect is present, defective pixel correction becomes unnecessary by using the short-exposure image. In this manner, in a case in which a defect is present only in the long-exposure image, defective pixel correction that generates a corrected pixel value by using the short-exposure image in the low-luminance region is effective.

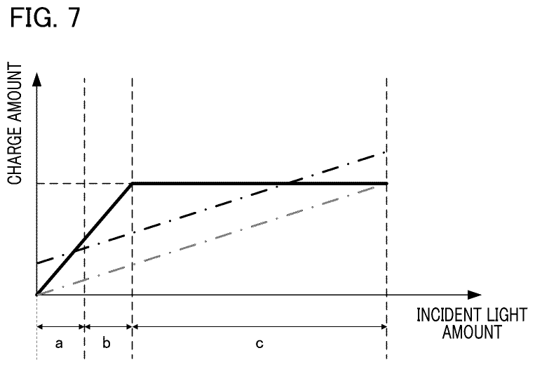

Next, a case in which a defect is present only in the short-exposure image will be explained. FIG. 7 is an explanatory diagram showing another example of charge amount transition in defective pixel correction of the second embodiment. In contrast to FIG. 5, an offset occurs in the charge amount in the defective pixel in the short-exposure image.

In the low-luminance region a and the intermediate-luminance region b of FIG. 7, since the long-exposure image is not saturated, the long-exposure image is used for HDR composition. Accordingly, even if a defect is present in the short-exposure image, the combined image is not affected. Since the long-exposure image is saturated in the high-luminance region c in FIG. 7, the short-exposure image is used.

In the high-luminance region, since the influence of the defect of the short-exposure image appears, defective pixel correction becomes necessary. However, in the high-luminance region, even if an attempt is made to perform defective pixel correction that uses a pixel signal output through a different path from a common photoelectric conversion unit as in the first embodiment, a corrected pixel value cannot be generated correctly because the long-exposure image is saturated.

Accordingly, a description is provided with respect to a driving method of the imaging element in the second embodiment for solving the above-described problem. Note that in the equivalent circuit diagram of FIG. 3, the charge holding portion MEM1_L22 is used as the charge holding portion for long exposure, and the charge holding portion MEM1_S23 is used as the charge holding portion for short exposure.

In the second embodiment, in a case in which a defect is present in MEM1_S23 that is the charge holding portion for short exposure, the roles of MEM1_L22 and MEM1_S23 are switched, and MEM1_S23 is used as a charge holding portion for long exposure and MEM1_L22 is used as a charge holding portion for short exposure.

That is, in a case in which a defect in the second charge holding portion is detected, charge accumulated in the photoelectric conversion unit during the first exposure time is held in the second charge holding portion, and charge accumulated during only the second exposure time shorter than the first exposure time in the photoelectric conversion unit is held in the first charge holding portion.

As a result, a defect occurs in the charge holding portion for long exposure, and since MEM1_L22 is not saturated, defective pixel correction becomes possible by using the output pixel value of MEM1_L22, as described in the first embodiment.

In this case, the roles of the charge holding portions only for some of the defective pixels are switched. Additionally, the pixel signals of the long-exposure image and the short-exposure image are switched by changing the readout order and the like, and HDR combining is performed by using information of roles of the charge holding portions.

It should be noted that, although switching of only the pixel of the charge holding portion having a defect is exemplified here, roles may be switched collectively by checking the number of defects of the charge holding portions for each row or all pixels such that the defect of the charge holding portion is used for long exposure.

That is, in the same row, in a case in which the number of pixels having a defective pixel in the charge holding portion for short exposure time is equal to or greater than a predetermined value, the charge holding portion for short exposure time of that row may be switched to be used as the charge holding portion for long exposure time. Alternatively, in all pixels, in a case in which the number of pixels having a defective pixel in the charge holding portion for short exposure time is equal to or greater than a predetermined value, the charge holding portion for short exposure time of all pixels may be switched to be used as the charge holding portion for long exposure time.

Thus, in a case in which the number of defects in the second charge holding portion of the plurality of pixels is larger than the number of defects in the first charge holding portion, the charge accumulated in the photoelectric conversion unit during the first exposure time may be held in the second charge holding portion across the plurality of pixels. Additionally, in this case, the charge accumulated for only the second exposure time shorter than the first exposure time in the photoelectric conversion unit may be held in the first charge holding portion.

Note that in the first and second embodiments, it is sufficient to perform defective pixel correction by using a pixel signal output through a different path from a common photoelectric conversion unit, and the circuit configuration need not be the circuit configuration exemplified in FIG. 3, and for example, the number of the charge holding portions is not limited to two. Furthermore, even in a circuit configuration including other circuit elements, if the circuit configuration is one that performs defective pixel correction by using a pixel signal output through a different path from a common photoelectric conversion unit, the circuit configuration is included in these embodiments.

### Third Embodiment

In the first and second embodiments, an explanation was provided with respect to a method of performing defective pixel correction by using a pixel signal output through a different path from a common photoelectric conversion unit. In the third embodiment, defective pixel correction is performed by using pixel signals output from another adjacent photoelectric conversion unit within the same pixel.

Similar to the first embodiment and the second embodiment, the defective pixel correction unit in the third embodiment does not generate an interpolation pixel value by using pixel signals from surrounding pixels, and therefore, favorable defective pixel correction is possible for a subject having high contrast and high spatial frequency.

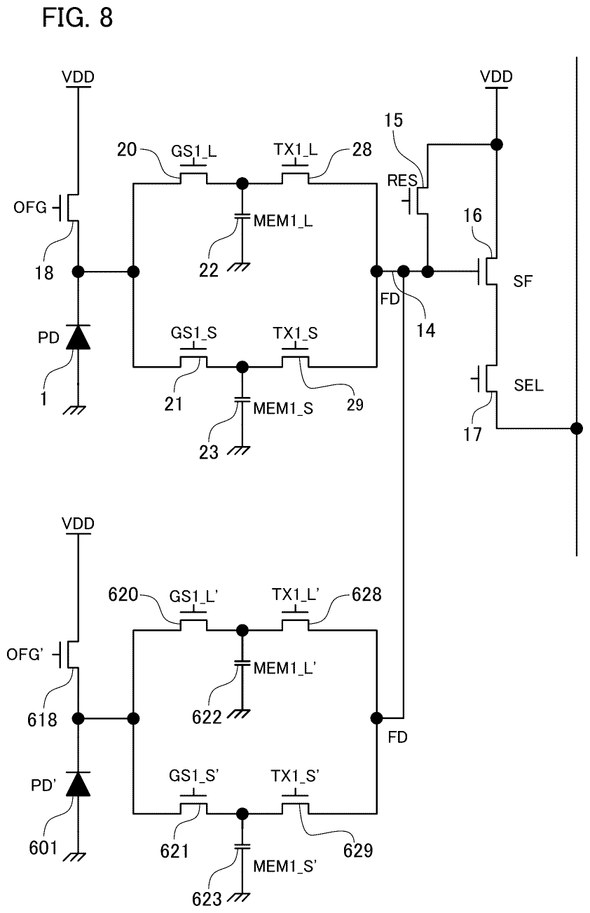

FIG. 8 is an equivalent circuit diagram of an imaging element according to the third embodiment. The equivalent circuit shown in FIG. 8 includes a photoelectric conversion unit PD′ 601 and charge holding portions MEM1_L′ 622 and MEM1_S′ 623, in addition to the equivalent circuit shown in FIG. 3. Furthermore, the equivalent circuit of FIG. 8 further includes charge transfer units GS1_L′ 620 and GS1_S′ 621, transfer units TX1_L′ 628 and TX1_S′ 629, and a charge discharge control unit OFG′ 618.

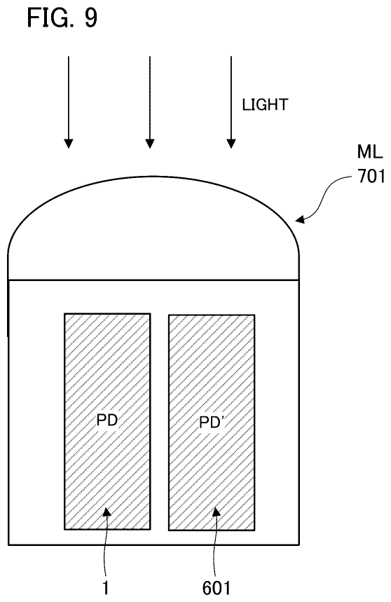

Since the functions and control methods of each unit are similar to those in FIG. 3, and an explanation thereof will be omitted. FIG. 9 is a schematic diagram of a cross-section of each pixel (each photoelectric conversion pixel) of the imaging element according to the third embodiment. The photoelectric conversion unit PD1 (first photoelectric conversion unit) and PD′ 601 (second photoelectric conversion unit) are arranged below a micro lens ML701 and share the micro lens ML701 for light collection.

Accordingly, the amount of signal charge generated in PD1 and PD′ 601 changes according to the angle of light incident on the pixel. That is, PD1 and PD′ 601 receive light from different exit pupils of the imaging lens. Therefore, by detecting a phase difference between an image signal obtained from a plurality of photoelectric conversion units PD1 and an image signal obtained from a plurality of photoelectric conversion units PD′601, a distance to a subject can be calculated.

Note that, here, the charge holding portion MEM1_L22 functions as a first charge holding portion for holding the output of the first photoelectric conversion unit, and the charge holding portion MEM1_L′ 622 functions as a first charge holding portion for holding the output of the second photoelectric conversion unit.

Additionally, the charge holding portion MEM1_S23 functions as a second charge holding portion for holding the output of the first photoelectric conversion unit, and the charge holding portion MEM1_S′ 623 functions as a second charge holding portion for holding the output of the second photoelectric conversion unit.

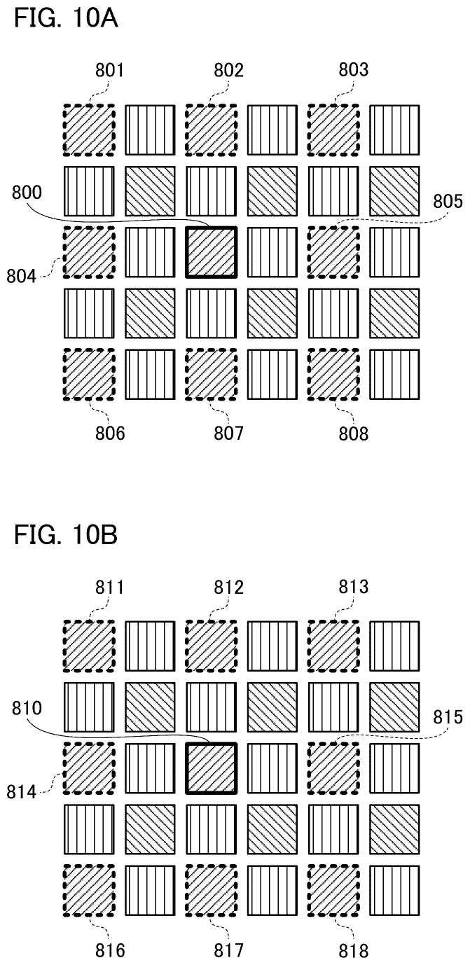

FIGS. 10A and 10B are explanatory views showing an example of defective pixel correction according to the third embodiment and illustrate an image plane during long exposure output from the imaging element having the configuration shown in FIG. 8. FIG. 10A shows an image plane photoelectrically converted by the photoelectric conversion unit PD1 and output via the charge holding portion MEM1_L22 during long exposure.

FIG. 10B illustrates an image plane during long exposure accumulated in PD'601, which shares the micro lens ML701 with PD1, and is output via the charge holding portion MEM1_L′ 622. In the present embodiment, an example of defective pixel correction in a case in which a defect is present in the charge holding portion MEM1_L22 of the pixel 800 is described. Note that it is assumed that in each pixel shown in FIGS. 10A and 10B, a color filter of a Bayer array, similar to that shown in FIGS. 4A and 4B are arranged.

Pixel 800 shows a signal of a pixel in the image plane for long exposure time obtained by photoelectrically converting light through a common microlens for long exposure time (long accumulation time) by PD1, and pixel 810 shows a signal of a pixel in the image plane for long exposure time obtained by photoelectrically converting light through a common microlens for long exposure time by PD′601.

In a case in which there is no defect in the charge holding portion, the subject is uniform, and the parallax between PD1 (first photoelectric conversion unit) and PD'601 (second photoelectric conversion unit) is small, the output pixel value of the pixel 800 and the output pixel value of the pixel 810 become close values. Therefore, in the present embodiment, for example, in a case in which a defect is present in the charge holding portion MEM1_L22 for long-exposure of the pixel 800, an interpolation pixel value for the charge holding portion MEM1_L22 during long exposure of the pixel 800 is calculated based on the output pixel value of pixel 810.

That is, in a case in which a defect is present in the first charge holding portion (MEM1_L22) for the first photoelectric conversion unit of the predetermined pixel, the interpolation pixel value is calculated based on the pixel value output from the first charge holding portion (MEM1_L′ 622) for the second photoelectric conversion unit of the pixel. Then, the pixel value from the first charge holding portion for holding the output of the first photoelectric conversion unit is interpolated using this interpolation pixel value.

Hereinafter, an example of calculation of the interpolation pixel value in the third embodiment will be explained. First, in the image plane shown in FIG. 10A, the variance of the pixel values of the surrounding pixels 801 to 808 around pixel 800 is calculated. Similarly, in the image plane shown in FIG. 10B, a variance of pixel values of the surrounding pixels 811 to 818 is calculated.

Next, the difference between the two variances calculated as described above is calculated, and a determination is made as to whether or not the difference is equal to or less than a predetermined threshold. In a case in which the difference of the variances is equal to or less than the threshold value, a difference between pixel values output from two adjacent photoelectric conversion units sharing a microlens is calculated.

That is, specifically, the difference in pixel values between the surrounding pixel 801 and the surrounding pixel 811 is calculated, and subsequently, the difference in pixel values between the pixel 802 and the pixel 812 is calculated. Subsequently, the differences in pixel values for other surrounding pixels are calculated in a similar manner. An average value of the plurality of differences obtained in this way is then calculated, and a value obtained by multiplying this average value by the pixel value of pixel 800 is set as the interpolation pixel value. Subsequently, a defective pixel correction process is performed by replacing the pixel value of the defective pixel with the above-described interpolation pixel value.

As described above, in the present embodiment, defective pixel correction is performed by using the output pixel value from another photoelectric conversion unit that shares a micro lens with the photoelectric conversion unit corresponding to the pixel 800. It should be noted that the intention of comparing the difference of the variances with the threshold value is to avoid a decrease in calculation accuracy of the interpolation pixel value because the variances calculated in each image plane become large for a subject having high spatial frequency or high contrast.

Additionally, the intention of calculating the average value of the differences between the output pixel values of two adjacent photoelectric conversion units that share a micro lens is to reduce the influence of parallax. It should be noted that although in the present embodiment, the variance or the average is used in the process of calculating the correction pixel value, for example, a standard deviation, median, or other statistical values may also be used.

### Fourth Embodiment

In the fourth embodiment, a method that enables effective defective pixel correction even in a case which surrounding pixels are used will be explained. That is, in the fourth embodiment, in a case in which a defect is present in the first charge holding portion of a predetermined pixel, an interpolation pixel value for interpolating the pixel value from the first charge holding portion is calculated based on the pixel value output from the second charge holding portion of the pixel and the pixel values of pixels surrounding the predetermined pixel.

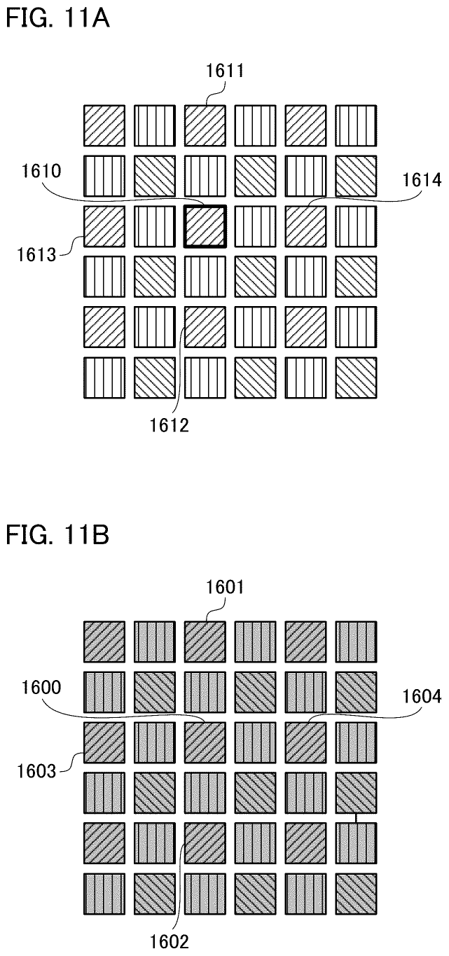

First, with reference to FIG. 11, a correction method according to the fourth embodiment will be explained for cases in which a defect is present in the charge holding portion of the pixel structure described above.

FIGS. 11A and 11B are explanatory views showing an example of pixel correction in the case in which a defect is present in the charge holding portion in the fourth embodiment. FIG. 11A shows an example of a long-exposure image, and FIG. 11B shows an example of a short-exposure image. Note that in each pixel shown in FIGS. 11A and 11B, it is assumed that a color filter of a Bayer array, similar to that shown in FIGS. 4A and 4B, are arranged.

FIG. 11A shows a state in which a defect occurs in the charge holding portion of an R pixel 1610 in the long-exposure image. Although an image is originally generated by combining a signal of the R pixel 1610 in the long-exposure image and a signal of an R pixel 1600 in the short-exposure image, in this case, since a defect occurs in the charge holding portion of the R pixel 1610 in the long-exposure image, image quality deterioration occurs if combining is performed in this state.

Accordingly, in the present embodiment, interpolation of the R pixel 1610 in the long-exposure image in which a defect has occurred is performed using information on surrounding R pixels. To achieve this, first, the relation with the surrounding pixels is calculated using the signal from the charge holding portion in the short-exposure image, in which no defect has occurred, and that is connected to the same photoelectric conversion unit as the charge holding portion in the long-exposure image in which a defect has occurred.

Specifically, ratios of signal levels between the R pixel 1600 of the short-exposure image that does not have a defect and the upper, lower, left, and right R pixels 1601, 1602, 1603, 1604 of the same color in the short-exposure image are calculated.

In this context, the signal level of R pixel 1600 in the short-exposure image, in which no defect has occurred, is denoted as short_R. Additionally, the signal level of the R pixel 1601 in the short-exposure image of the same color located above the R pixel 1600 is defined as short_top_R, the signal level of the R pixel 1602 in the short-exposure image of the same color located below the R pixel 1600 is defined as short_bottom_R, the signal level of the R pixel 1603 in the short-exposure image of the same color located to the left of the R pixel 1600 is defined as short_left_R, and the signal level of the R pixel 1604 in the short-exposure image of the same color located to the right of the R pixel 1600 is defined as short_right_R. The relation between the R pixel 1600 and the surrounding R pixels 1601, 1602, 1603, and 1604 is obtained as follows.

Ratio to the upper R pixel 1601:

$$top\_cor \_R = short\_R / short\_top \_R$$

Ratio to the lower R pixel 1602:

$$bottom\_cor \_R = short\_t / short\_bottom \_R$$

Ratio to the left R pixel 1603:

$$left\_cor \_R = short\_R / short\_left \_R$$

Ratio to the right R pixel 1604

$$right\_cor \_R = short\_R / short\_right \_R$$

Next, based on the relation with the surrounding pixels in the short-exposure image as calculated above, the interpolation pixel value for the R pixel 1610 in the long-exposure image, in which a defect has occurred, is calculated by performing a weighted averaging as follows.

In this context, the signal level of the R pixel 1610 in the long-exposure image, in which a defect has occurred, is denoted as long_R. Additionally, the signal level of the R pixel 1611 in the long-exposure image, which is a same-color pixel as the R pixel 1610 and located above the R pixel 1610, is defined as long_top_R, the signal level of the R pixel 1612 in the long-exposure image, which is a same-color pixel as the R pixel 1610 and located below the R pixel 1610, is defined as long_bottom_R, the signal level of the R pixel 1613 in the long-exposure image, which is a same-color pixel as the R pixel 1610 and located to the left of the R pixel 1610, is defined as long_left_R, and the signal level of the R pixel 1614 in the long-exposure image, which is a same-color pixel as the R pixel 1610 and located to the right of the R pixel 1610, is defined as long_right_R.

$$long\_R = \{ ( top\_cor \_R \times long\_top \_R ) + ( bottom\_cor \_R \times long\_bottom \_R ) + ( left\_cor \_R \times long\_left \_R ) + ( right\_cor \_R \times long\_right \_R ) \} / 4$$

In the present embodiment, the charge holding portion for long accumulation and the charge holding portion for short accumulation are connected to the same photoelectric conversion unit. Therefore, even in a case in which a defect occurs in the charge holding portion for long accumulation or in the charge holding portion for short accumulation, it is possible to perform satisfactory defective pixel correction by calculating an interpolation pixel value based on the relationship between the defective pixel and the surrounding pixels in which no defect has occurred, as described above.

In this manner, in the present embodiment, when defective pixel correction is performed using pixel signals output from a shared photoelectric conversion unit through different paths, an interpolation pixel value is calculated based on the charge holding portion of the path in which no defect has occurred, and the pixel values of the surrounding pixels. Accordingly, more favorable defective pixel correction can be performed.

It should be noted that, although an explanation is provided with respect to a case in which the charge holding portion for long-exposure accumulation has a defect, it is also possible to similarly calculate using information of pixels of the long-exposure image in a case in which the charge holding portion for short-exposure accumulation has a defect.

### Fifth Embodiment

Next, in the fifth embodiment, an example of correction processing in a case in which a defect is present in the FD region will be explained.

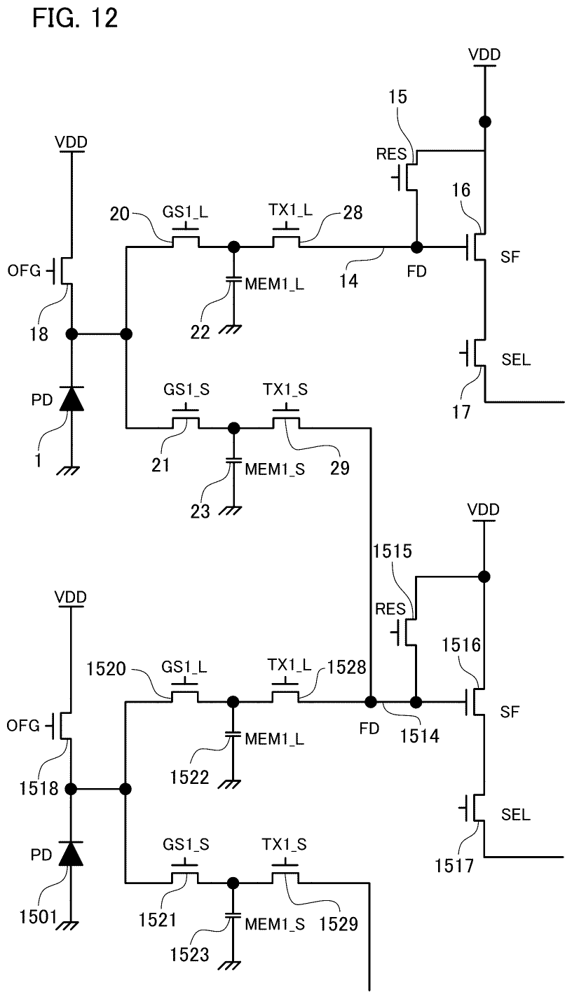

FIG. 12 is an equivalent circuit diagram of an imaging element according to the fifth embodiment, and illustrates a configuration example in which one FD region is shared by two charge holding portions. In FIG. 12, a charge holding portion MEM1_S23 for short accumulation of the photoelectric conversion unit PD1 and a charge holding portion MEM1_L1522 for long accumulation of a photoelectric conversion unit PD1501 are connected to each other. In this context, it is assumed that the photoelectric conversion unit PD1501 is the photoelectric conversion unit of a pixel adjacent to the lower side of PD1.

In the configuration shown in FIG. 12, when a defect occurs in the FD region, interpolation processing can be performed based on the assumption that the defect is equivalent to one occurring in two vertically arranged charge holding portions. Here, a correction process in such a case will be explained.

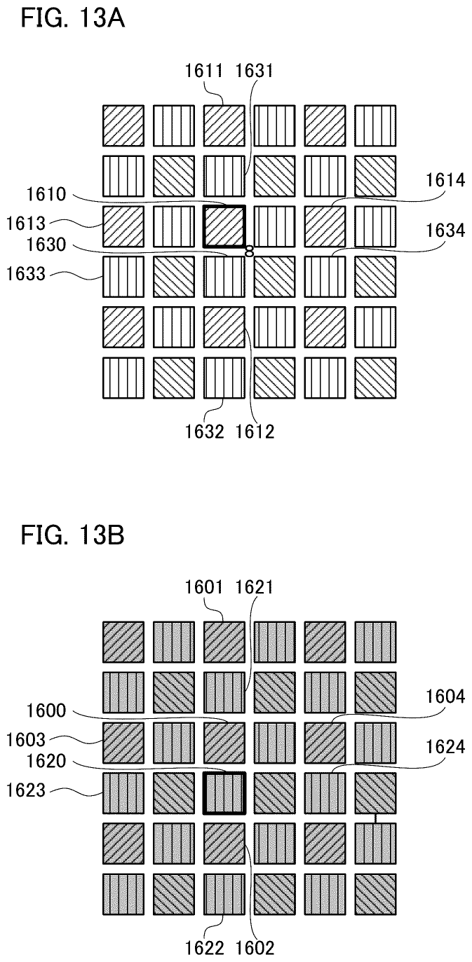

FIGS. 13A and 13B are explanatory views showing an example of pixel correction in a case in which a defect occurs in the FD region according to the fifth embodiment, wherein FIG. 13A illustrates an image plane output from the imaging element in a long-exposure image, and FIG. 13B illustrates an image plane output from the imaging element in a short-exposure image.

In FIG. 13A, the R pixel 1610 of the long-exposure image is shown as a pixel read out from an FD region in which a defect has occurred, and in FIG. 13B, the G pixel 1620 of the short-exposure image is shown as a pixel read out from the same FD region in which a defect has occurred. It should be noted that although in FIG. 12, PD1 is disposed above PD1501, FIG. 13 illustrates an example in which PD1 is disposed below PD1501.

Since the G pixel 1620 in the short-exposure image and the R pixel 1610 of the long-exposure image are both read out from the same defective FD region, image degradation occurs if combining is performed in this state. Accordingly, correction processing is performed by using surrounding pixel information for the G pixel 1620 of the short-exposure image and the R pixel 1610 of the long-exposure image that are connected to the FD region in which a defect has occurred.

By using a similar method to the case in which a defect is present in the charge holding portion described above, it is possible to correct the G pixel of the short-exposure image and the R pixel of the long-exposure image.

First, a method for correcting the G pixel 1620 in the short-exposure image will be explained. Specifically, ratios of signal levels between the G pixel 1630 of the long-exposure image and the upper, lower, left, and right G pixels 1631, 1632, 1633, 1634 of the same color in the long-exposure image are calculated.

The signal level of G pixel 1630 is denoted as long_G, the signal level of the G pixel 1631, which is located above the signal level of G pixel 1630 is defined as long_top_G, the signal level of the G pixel 1632, which is located below the signal level of G pixel 1630 is defined as long_bottom_G, the signal level of the G pixel 1633, which is located to the left of the signal level of G pixel 1630 is defined as long_left_G, and the signal level of the G pixel 1634, which is located to the right of the signal level of G pixel 1630 is defined as long_right_G. The relationship between the G pixel 1630 and each of the surrounding G pixels 1631, 1632, 1633, and 1634 is obtained as follows.

Ratio to the upper G pixel 1631:

$$top\_cor \_G = long\_G / long\_top \_G$$

Ratio to the lower G pixel 1632:

$$bottom\_cor \_G = long\_G / long\_bottom \_G$$

Ratio to the left pixel 1633:

$$left\_cor \_G = long\_G / long\_left \_G$$

Ratio to the right pixel 1634:

$$right\_cor \_G = long\_G / long\_right \_G$$

Next, using the relation with surrounding pixels in the long-exposure image calculated here, an interpolated pixel value of the G pixel 1620 connected to the FD region in which a defect has occurred is calculated by averaging as shown below.

In this context, the signal level of the G pixel 1620 for short accumulation in which a defect occurs is denoted as short_G. Additionally, the signal level of the G pixel 1621 for short accumulation, which is a same-color pixel as the G pixel 1620 and located above the G pixel 1620, is defined as short_top_G, the signal level of the G pixel 1622 for short accumulation, which is a same-color pixel as the G pixel 1620 and located below the G pixel 1620, is defined as short_bottom_G, the signal level of the G pixel 1623 for short accumulation, which is a same-color pixel as the G pixel 1620 and located to the left of the G pixel 1620, is defined as short_left_G, and the signal level of the G pixel 1624 for short accumulation, which is a same-color pixel as the G pixel 1620 and located to the right of the G pixel 1620, is defined as short_right_G.

$$short\_G = \{ ( top\_cor \_G \times short\_top \_G ) + ( bottom\_cor \_G \times short\_bottom \_G ) + ( left\_cor \_G \times short\_left \_G ) + ( right\_cor \_G \times short\_right \_G ) \} / 4$$

Additionally, for the other R pixel 1610 connected to the FD region in which a defect has occurred, an interpolation pixel value can be calculated using the same method as described above.

In this manner, the Fifth Embodiment enables favorable correction processing using surrounding pixels by calculating interpolation pixel values using surrounding pixels for each of the G pixel of the short-exposure image and the R pixel of the long- exposure image connected to the FD region in which a defect has occurred.

### Sixth Embodiment

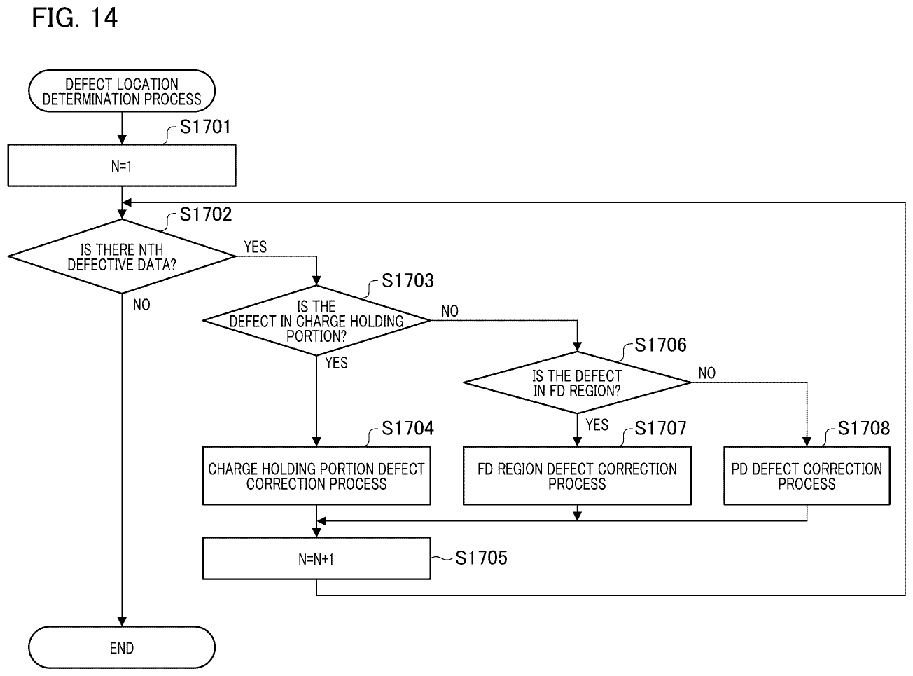

Next, using flowcharts of FIG. 14 to FIG. 16, an explanation is provided for defective pixel correction processing executed in the defective pixel correction unit 217 of the sixth embodiment. It should be noted that operations of each step of the flowcharts of FIG. 14 to FIG. 16 are performed sequentially by a CPU or the like serving as a computer in the imaging apparatus 200 executing a computer program stored in a memory.

FIG. 14 is a flowchart illustrating an example of a processing method according to the sixth embodiment and is a flowchart for explaining an example of performing defect type determination processing for performing correction processing on a defect.

First, N defective pixel data stored in the ROM in advance are read in order from the first. For this purpose, in step S1701, the data number to be read is set to N=1, and in step S1702, a determination is made as to whether the Nth defective pixel data exists.

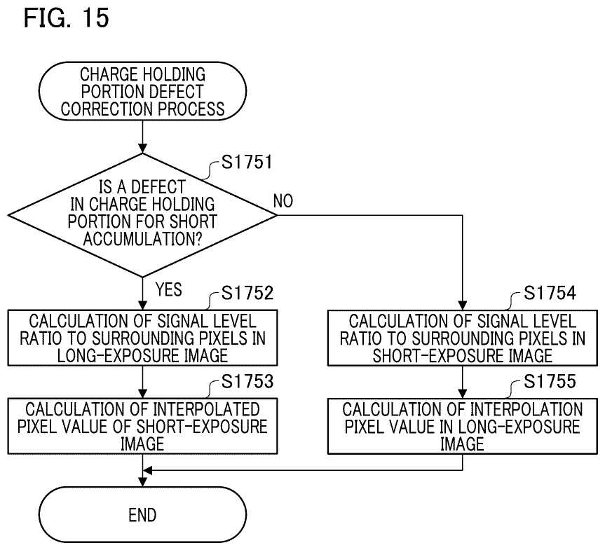

In a case in which defective pixel data is determined to exist in step S1702, in step S1703, a determination is made as to whether the type (location) of the defect is a charge holding portion. In a case in which the defect is determined to be in the charge holding portion in step S1703, in step S1704, defect correction processing for the charge holding portion as described below in FIG. 15 is executed.

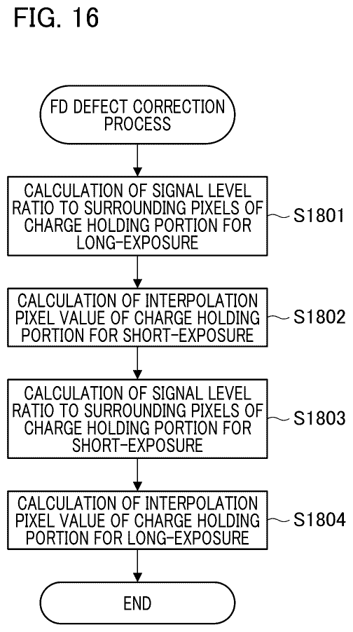

In a case in which the defect is determined not to be in the charge holding portion in step S1703, in step S1706, a determination is made as to whether the defect is in the FD region. In a case in which the defect is determined to be in the FD region in step S1706, in step S1707, defect correction processing for the FD region as described below in FIG. 16 is executed.

When it is determined in step S1706 that the defect is not in the FD region, in step S1708, correction processing by average value interpolation using pixel values of surrounding pixels is executed for correcting a defect of PD.

In this context, step S1708 functions as the calculation step (calculation unit) for calculating an interpolation pixel value for interpolating the pixel value from the first charge holding portion, based on the pixel values of the surrounding pixels in a case in which a defect has occurred in the first charge holding portion of the predetermined pixel. Additionally, operation of the calculation unit is controlled according to the type of defect determined in steps S1702, S1703, S1706, and the like.

After correction processing according to the defective part (steps S1704, S1707, S1708) is performed, in step S1705, N=N+1 is set to read the next defective pixel data, the process returns to step S1702, and the above-described processing is repeatedly executed.

When all defective pixel data reading is completed in step S1702 and the Nth defective pixel data is determined to be absent, the flow for defect type determination processing in FIG. 14 ends.

As described above, the flow in FIG. 14 illustrates defective pixel correction processing steps performed by the defective pixel correction unit 217 in the present embodiment. Additionally, in the above defect pixel correction step, in a case in which a defect is present in a first charge holding portion of a predetermined pixel, an interpolated pixel value for interpolating the pixel value from the first charge holding portion is calculated based on the pixel value output from a second charge holding portion of the pixel.

FIG. 15 is a flowchart explaining an example of correction processing in a case in which a defect is present in the charge holding portion in the sixth embodiment and shows an example of the processing of step S1704. Note that the correction processing shown in FIG. 15 corresponds to the processing described in the first through fourth embodiments.

When the correction processing in FIG. 15 starts, in step S1751, it is determined whether or not a defect is present in the charge holding portion for short accumulation. In a case in which a defect is determined to be in the charge holding portion for short-exposure accumulation in step S1751, in step S1752, charge holding portion correction processing for short-exposure accumulation is performed.

That is, in step S1752, a signal level ratio to the surrounding pixels of the long-exposure image is calculated. Specifically, a ratio of signal levels between a pixel signal of the long-exposure image obtained from the charge holding portion for long-exposure accumulation connected to the same photoelectric conversion unit as the photoelectric conversion unit connected to the charge holding portion for short-exposure accumulation in which a defect is present, and pixel signals of surrounding pixels of the long-exposure image is calculated.

Next, in step S1753, an interpolation pixel value for the short-exposure image is calculated. Specifically, an interpolation pixel value of the short-exposure image in which a defect has occurred is calculated by using signal levels of pixel signals of surrounding pixels of the short-exposure image and the signal level ratio of pixel signals of the long-exposure image calculated in advance.

In contrast, in a case in which the defect is determined not to be in the charge holding portion for short-exposure accumulation in step S1751, a defect has occurred in the charge holding portion for long-exposure accumulation, and the process proceeds to step S1754.

In step S1754, a signal level ratio to the surrounding pixels in the short-exposure image is calculated for charge holding portion interpolation processing for long accumulation. Specifically, in step S1754, a ratio of signal levels between a pixel signal of the short-exposure image obtained from the charge holding portion for short-exposure accumulation connected to the same photoelectric conversion unit as the photoelectric conversion unit connected to the charge holding portion for long-exposure accumulation in which a defect is present, and pixel signals of surrounding pixels of the short-exposure image is calculated.

Next, in step S1755, the interpolation pixel value of the long-exposure image is calculated. That is, an interpolation pixel value of the long-exposure image in which a defect has occurred is calculated using levels of pixel signals of surrounding pixels of the long-exposure image and the signal level ratio of pixel signals of the short-exposure image calculated in advance.

FIG. 16 is a flowchart illustrating an example of correction processing in a case in which a defect is present in the FD region in the sixth embodiment, and shows an example of the processing of step S1707. Note that the correction processing shown in FIG. 16 corresponds to the processing described in the fifth embodiment, and in a case in which a defect is present in the FD region, a process of calculating interpolated pixel values in the short-exposure image and the long-exposure image connected to the FD region in which a defect has occurred is performed.

First, in step S1801, for charge holding portion correction processing of the short-exposure image, a signal level ratio between surrounding pixels of the long-exposure charge holding portion is calculated. Specifically, a ratio of signal levels between a pixel signal of the long-exposure image obtained from the charge holding portion for long-exposure accumulation connected to the same photoelectric conversion unit as the photoelectric conversion unit connected to the charge holding portion for short-exposure accumulation in which a defect is present, and pixel signals of surrounding pixels of the long-exposure image are calculated.

Next, in step S1802, an interpolation pixel value of the short-exposure charge holding portion is calculated. That is, an interpolation pixel value of the short-exposure image in which a defect has occurred is calculated by using levels of pixel signals of surrounding pixels of the short-exposure image and the signal level ratio of pixel signals of the long-exposure image calculated in advance.

Next, as charge holding portion correction processing in the long-exposure image, in step S1803, ratio between the signal level of the short-exposure charge holding portion and the level of the surrounding pixels of the short-exposure charge holding portion is calculated. Specifically, a ratio of signal levels between a pixel signal of the short-exposure image obtained from the charge holding portion for short-exposure accumulation connected to the same photoelectric conversion unit as the photoelectric conversion unit connected to the charge holding portion for long-exposure accumulation in which a defect is present, and pixel signals of surrounding pixels of the short-exposure image is calculated.

Next, in step S1804, an interpolation pixel value of the long-exposure charge holding portion is calculated. That is, an interpolation pixel value of the long-exposure image in which a defect has occurred is calculated by using levels of pixel signals of surrounding pixels of the long-exposure image and the signal level ratio of pixel signals of the short-exposure image calculated in advance.

### Seventh Embodiment

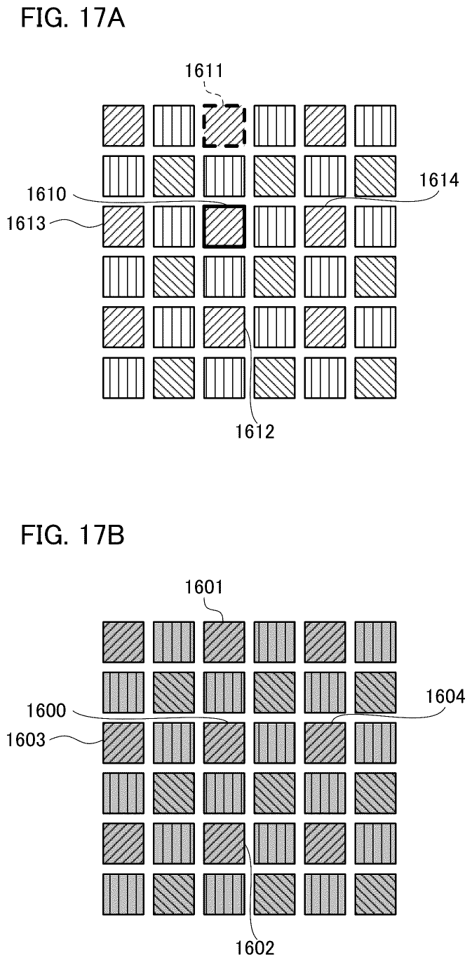

Next, FIGS. 17A and 17B are diagrams for explaining an example of defective pixel correction in the seventh embodiment, and are diagrams for explaining a processing example in a case in which some of the charge holding portions among the charge holding portions of surrounding pixels used for correction processing are saturated. Note that in FIGS. 17A and 17B, the same reference numerals as those in FIG. 11A and 11B denote the same components.

As described above, GS1_L20 may be turned on and GS1_S21 may be turned off during long exposure (long duration) in PD1, and GS1_L20 may be turned off and GS1_S21 may be turned on during short-exposure (short duration) photoelectric conversion in PD1. In this case, in a case in which a bright subject is captured, a state in which the charge holding portion used for long accumulation becomes saturated beyond the charge amount that can be accumulated in the charge holding portion can be considered.

In a case in which the charge holding portion is saturated (in a case in which the pixel value is equal to or greater than a predetermined threshold value), the correct signal level cannot be read out, and performing correction processing in this state leads to a deterioration in image quality. Therefore, in such a case, correction processing is performed by using pixel information from charge holding portions that are not saturated. That is, in the present embodiment, among pixel values of surrounding pixels, pixel values equal to or greater than the predetermined threshold value is excluded from the calculation of the interpolation pixel value.

FIG. 17A illustrates a case in which a part of the long-exposure image is saturated, and shows a state in which a defect has occurred in the R pixel 1610 of the long-exposure image and the upper R pixel 1611 is saturated. Note that FIG. 17B illustrates an example of a short-exposure image, similar to FIG. 11B.

In this case, the relationship between the surrounding pixels is calculated by using the short-exposure image by the method explained with reference to FIG. 11, and since the pixel located above the pixel in which a defect has occurred in the long-exposure image is saturated, correction processing is performed by excluding the saturated pixel. That is, the interpolation pixel value in the long-exposure image is calculated by averaging the values of the surrounding pixels excluding the saturated ones as described below.

$$long\_R = \{ ( bottom\_cor \_R \times long\_bottom \_R ) + ( left\_cor \_R \times long\_left \_R ) + ( right\_cor \_R \times long\_right \_R ) \} / 3$$

### Eighth Embodiment

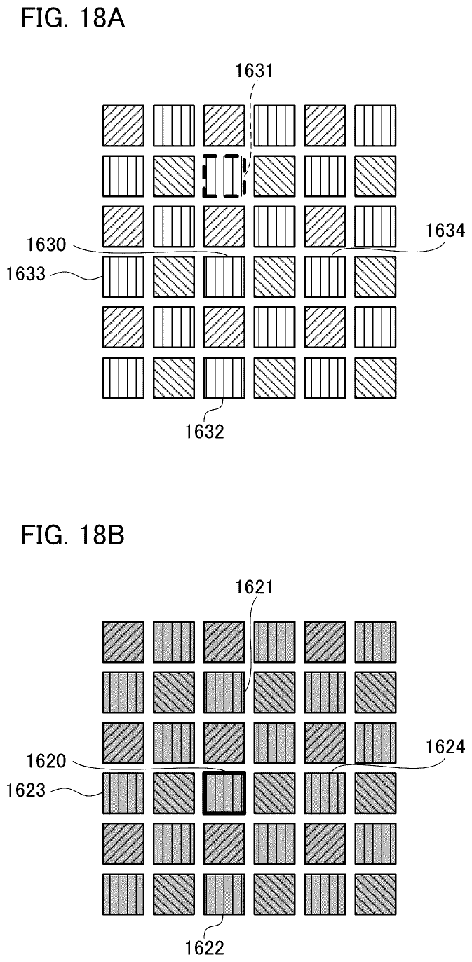

FIGS. 18A and 18B are diagrams for explaining an example of defective pixel correction in the eighth embodiment, wherein FIG. 18A shows an example of a long-exposure image, and FIG. 18B shows an example of a short-exposure image. In the eighth embodiment, an explanation is provided with respect to a correction method in a case in which a defect has occurred in the G pixel 1620 in the short-exposure image shown in FIG. 18B, and the G pixel 1631 in the long-exposure image is saturated.

In this case, since the relationship to the upper G pixel 1631 cannot be calculated by using the long-exposure image, interpolation processing is performed excluding the upper G pixel 1621. That is, the interpolation pixel value in the short-exposure image is calculated by averaging the pixel values of the surrounding G pixels, excluding the upper G pixel 1621, as described below.

$$short\_G = \{ ( bottom\_cor \_G \times short\_bottom \_G ) + ( left\_cor \_G \times short\_left \_G ) + ( right\_cor \_G \times short\_right \_G ) \} / 3$$

In this manner, in a case in which a saturated pixel is present, it is possible to calculate an interpolation pixel value by performing correction processing by excluding the saturated pixel.

### Ninth Embodiment

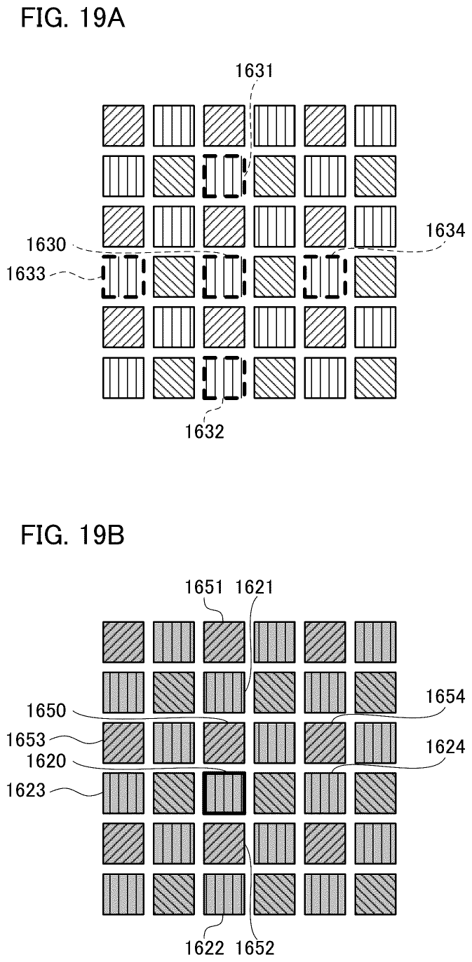

In the ninth embodiment, correction processing by using information of adjacent short-exposure images of different colors will be explained, in a case in which all pixels in the long-exposure image used for correction are saturated, with reference to FIG. 19.

FIGS. 19A and 19B are diagrams for explaining an example of defective pixel correction in the ninth embodiment, wherein FIG. 19A shows an example of a long-exposure image, and FIG. 19B shows an example of a short-exposure image. FIG. 19B illustrates a state in which a defect is present in the G pixel 1620 in the short-exposure image. In this case, using methods described so far, correction processing calculates the relationship between a G pixel 1630 and surrounding G pixels by using a G pixel 1630, a G pixel 1631, a G pixel 1632, a G pixel 1633, and a G pixel 1634 of the long-exposure image shown in FIG. 19A.

However, in the ninth embodiment, it is assumed that all of the G pixels 1630, 1631, 1632, 1634, and 1635 are saturated. In this state, when the correction processing explained above is performed, highly reliable correction cannot be achieved.

Therefore, in the ninth embodiment, correction processing is performed by using information of the short-exposure image of an R pixel that is, for example, a different color pixel adjacent to the upper side of the G pixel. Specifically, correction processing is performed by using an R pixel 1650 and an R pixel 1651, an R pixel 1652, an R pixel 1653, and an R pixel 1654 that are surrounding pixels of the R pixel 1650. In this case, the relationship between the R pixel 1650 and the surrounding pixels is calculated as follows.

Note that the signal level of the R pixel 1650 for short accumulation is defined as short_R. The signal level of the R pixel 1651 for short-duration accumulation of the same-color pixel in the top is defined as short_top_R, the signal level of the R pixel 1652 for short-duration accumulation of the same-color pixel in the bottom is defined as short_bottom_R, the signal level of the R pixel 1653 for short-duration accumulation of the same-color pixel in the left is defined as short_left_R, and the signal level of the R pixel 1654 for short-duration accumulation of the same-color pixel in the right is defined as short_right_R.

Ratio to the upper R pixel 1651:

$$top\_cor \_R = short\_R / short\_top \_R$$

Ratio to the lower R pixel 1652:

$$bottom\_cor \_R = short\_R / short\_bottom \_R$$

Ratio to the left R pixel 1653:

$$left\_cor \_R = short\_R / short\_left \_R$$

Ratio to the right R pixel 1654:

$$right\_cor \_R = short\_R / short\_right \_R$$

Then, the interpolation pixel value of the G pixel 1620 is calculated by averaging as shown below. It should be noted that, as described above, the signal level of the G pixel 1620 for short accumulation is denoted as short_G. Additionally, the signal level of the G pixel 1621 for short-duration accumulation in the top is defined as short_top_G, the signal level of the G pixel 1622 for short-duration accumulation in the bottom is defined as short_bottom_G, the signal level of the G pixel 1623 for short-duration accumulation in the left is defined as short_left_G, and the signal level of the G pixel 1624 for short-duration accumulation in the right is defined as short_right_G.

$$short\_G = \{ ( top\_cor \_R \times short\_top \_G ) + ( bottom\_cor \_R \times short\_bottom \_G ) + ( left\_cor \_R \times short\_left \_G ) + ( right\_cor \_R \times short\_right \_G ) \} / 4$$

In this manner, in a case in which the pixels of the color used for correction are saturated, correction processing may be performed by using information about adjacent pixels of a different color in which a defect has occurred.

### Tenth Embodiment

The defective pixel correction method in a case in which a defect is present in the charge holding portion or the floating diffusion part (FD) has been described above with reference to the first embodiment through the ninth embodiment. These methods of performing defective pixel correction prior to HDR composition processing can be broadly classified into two categories.

One method is a method that uses the output pixel values output through different paths within the same pixel, and, for example, the first embodiment to the third embodiment are included in this method, and these methods are referred to as, for example, a first defective pixel correction method. Another method is a method of calculating interpolated pixel values by using surrounding pixels, and, for example, the fourth embodiment, fifth embodiment, and seventh embodiment to ninth embodiment are included in this method, and these methods are referred to as, for example, a second defective pixel correction method.

In contrast, as a method of correcting defect pixels after HDR composition, for example, there is a method in which the median pixel value of surrounding pixels is used as the interpolated pixel value, which is a typical defect pixel correction means such as that performed in step S1708, and this method may be referred to as, for example, the third defect pixel correction method.

Since the third defective pixel correction method calculates correction pixel values from surrounding pixels, for a subject having high contrast and spatial frequency, more favorable defective pixel correction becomes possible by using the first defective pixel correction method or the second defective pixel correction method. In the tenth embodiment, switching of the defective pixel correction method is performed.

That is, in the first defective pixel correction method, defects occurring in the charge holding portion for long exposure are targeted for correction, whereas in the second defective pixel correction method, defects occurring in either the charge holding portion or the floating diffusion part are targeted. Accordingly, the first defective pixel correction method and the second defective pixel correction method are switched according to defect occurrence locations.

Additionally, in the first defective pixel correction method and the second defective pixel correction method, defective pixel correction is performed prior to the HDR composition processing. Since there may be a case in which defects do not become apparent after HDR combining processing depending on defect occurrence locations and pixel values, the defective pixel correction methods are switched considering the defect occurrence locations and pixel values.

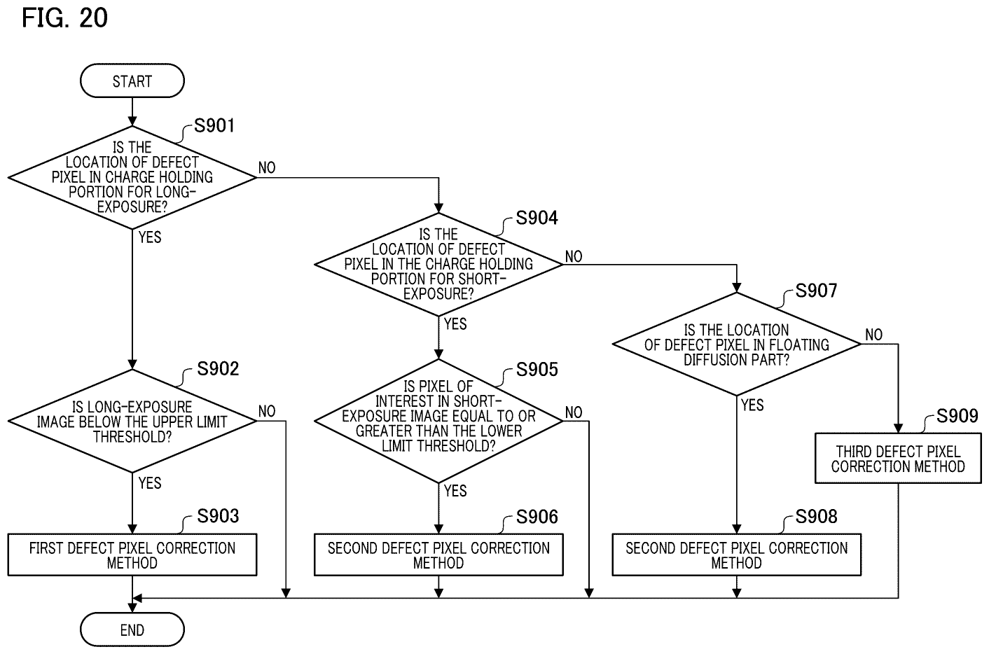

FIG. 20 is a flowchart illustrating an example of a processing method according to the tenth embodiment, and shows an example of the process for selecting a correction method. Note that the operations of each step in the flowchart in FIG. 20 are sequentially performed by a CPU and the like that serves as a computer in the imaging apparatus executing a computer program stored in a memory.

First, in step S901, it is determined whether the defect occurrence location of the defective pixel is the charge holding portion for long-exposure. In a case in which a defect is present in the charge holding portion for long exposure, it is determined in step S902 whether the long-exposure image is below a predetermined upper limit threshold value. That is, a determination is made as to whether a desired attention pixel of the long-exposure image is less than the upper limit threshold value. This upper limit threshold is, for example, set as an upper limit of the luminance range that uses the long-exposure image in HDR composition processing.

In a typical HDR composition process, the short-exposure image is used for high-brightness regions, and therefore, even if a defect is present in the long-exposure image, this does not affect the image after HDR composition processing. Therefore, in a case in which a determination is made as equal to or greater than the upper limit threshold value in step S902, defective pixel correction processing is not performed, and the flow of FIG. 20 ends. In contrast, in a case in which the attention pixel of the long-exposure image is determined to be less than the upper limit threshold value in step S902, defective pixel correction processing is performed according to the first defective pixel correction method in step S903, and then the flow of FIG. 20 ends.

In contrast, in a case in which the defect occurrence location of the defective pixel is determined not to be the charge holding portion for long-exposure in step S901, in step S904, a determination is made as to whether the defect occurrence location of the defective pixel is the charge holding portion for short-exposure. In a case in which a defect is determined to be present in the charge holding portion for short-exposure in step S904, in step S905, a determination is made as to whether the attention pixel of the short-exposure image is equal to or greater than a predetermined lower limit threshold value.

It is assumed that this lower limit threshold is, for example, the lower limit of the luminance range in which the short-exposure image is used in HDR combining processing. In a typical HDR composition process, the long-exposure image is used for the low-luminance regions, and therefore, even if a defect is present in the short-exposure image, there is no influence of the defect in the image after HDR composition processing. Therefore, if it is determined in step S905 that the pixel of interest in the short-exposure image is below the lower limit threshold, the flow shown in FIG. 20 ends without performing the defective pixel correction process. In contrast, if it is determined in step S905 that the pixel of interest in the short-exposure image is equal to or greater than the lower limit threshold, the flow of FIG. 20 ends after performing the defective pixel correction process using the second defective pixel correction method in step S906.

When it is determined in step S904 that the location where a defect pixel has occurred is not in the charge holding portion for short exposure, in step S907, a determination is made as to whether the defect occurrence location of the defective pixel is the floating diffusion part (FD). In a case in which a determination of “YES” is made in step S907, defective pixel correction processing is performed according to the second defective pixel correction method in step S908, and the flow of FIG. ends.

In a case in which the defect occurrence location of the defective pixel is determined not to be the floating diffusion part in step S907, defective pixel correction processing is performed according to the third defective pixel correction method in step S909, and the flow of FIG. 20 ends.

Next, as an example of a method for specifying a location where a defective pixel has occurred, an explanation is provided with respect to an example of a method of acquiring an image for defective pixel detection by turning ON/OFF each transfer unit. Since defective pixels mainly occur as what is referred to as “white defects” due to electrons leaking into the photoelectric conversion unit, the charge holding portion, or the floating diffusion part, resulting in excessive output, using an image in a light-shielded state is preferable for defective pixel detection.

For example, in the configuration of FIG. 3, in a case in which GS1_L20 and GS1_S21 are set to OFF, TX1_L28 is set to ON, and TX1_S29 is set to OFF, it is assumed that there is no defect present in the image. In this case, if GS1_L20 and GS1_S21 are set to OFF, TX1_L28 is set to OFF, and TX1_S29 is set to ON, and a defect is present in the image, it can be determined that the defect is present in MEM1_L22.

Although a method of estimation in a case in which a defect is present in the charge holding portion for long-exposure is shown here, estimation of the defect occurrence location from opening/closing of the transfer units and output results thereof is similarly possible for defects in the charge holding portion for short-exposure or the floating diffusion part.

Note that in the tenth embodiment, an example of switching between the first to third defective pixel correction methods depending on, for example, the location at which a defect pixel has occurred has been explained. However, the imaging apparatus may have four or more defect pixel correction methods, not limited to the first to third defect pixel correction methods as described above, and may switch between at least two of the defective pixel correction methods among the defective pixel correction methods.

Additionally, these two or more (plurality of) defective pixel correction methods may be switched according to at least one of type of defect, conditions of the subject (for example, brightness, contrast, frequency characteristics, and the like), and image capturing conditions (for example, exposure time, aperture, sensitivity, and the like).

That is, for example, the third defective pixel correction method (for example, the operation of the calculation unit performed in step S1708) and the like may be controlled according to at least one of the type of defect, the conditions of the subject, and the image capturing conditions. Such methods are also included in the present embodiment.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the imaging apparatus and the like through a network or various storage media. Then, a computer (or a CPU, an MPU, or the like) of the imaging apparatus and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-099067, filed on Jun. 19, 2024, which is hereby incorporated by reference herein in its entirety.

What is claimed is:

1. An imaging apparatus comprising:
an imaging element having a plurality of pixels each including a photoelectric conversion unit, a first charge holding portion for holding an output of the photoelectric conversion unit, and a second charge holding portion for holding an output of the photoelectric conversion unit, and
at least one processor or circuit configured to function as:
a defective pixel correction unit configured to calculate an interpolation pixel value for interpolating a pixel value from the first charge holding portion based on a pixel value output from the second charge holding portion of the pixel in a case in which a defect is present in the first charge holding portion of a predetermined pixel.

2. The imaging apparatus according to claim 1, wherein the pixel includes a first charge transfer unit configured to transfer a charge from the photoelectric conversion unit to the first charge holding portion; a second charge transfer unit configured to transfer a charge from the photoelectric conversion unit to the second charge holding portion; and a floating diffusion part to which charge from the first charge holding portion and charge from the second charge holding portion are transferred.

3. The imaging apparatus according to claim 1, wherein charge accumulated during a first exposure time in the photoelectric conversion unit is held in the first charge holding portion, and charge accumulated during a second exposure time shorter than the first exposure time in the photoelectric conversion unit is held in the second charge holding portion.

4. The imaging apparatus according to claim 3, wherein the defective pixel correction unit is configured to calculate the interpolation pixel value based on a pixel value read out from the second charge holding portion according to a ratio between the first exposure time and the second exposure time.

5. The imaging apparatus according to claim 1, wherein, in a case in which a defect in the second charge holding portion is detected, charge accumulated during a first exposure time in the photoelectric conversion unit is held in the second charge holding portion, and a charge accumulated during a second exposure time shorter than the first exposure time in the photoelectric conversion unit is held in the first charge holding portion.

6. The imaging apparatus according to claim 1, wherein, in a case in which the number of defects in the second charge holding portions of the plurality of pixels is larger than the number of defects in the first charge holding portions, in the plurality of pixels, the charge accumulated during the first exposure time in the photoelectric conversion units are held in the second charge holding portions, and the charge accumulated during a second exposure time shorter than the first exposure time in the photoelectric conversion units are held in the first charge holding portions.

7. The imaging apparatus according to claim 1, wherein the at least one processor or circuit is further configured to function as:
a combining processing unit configured to combine signals read out from the imaging element and generate a high dynamic range image,
wherein defective pixel correction processing by the defective pixel correction unit is performed before combining processing by the combining processing unit.

8. The imaging apparatus according to claim 1, wherein the defective pixel correction unit includes,
a calculation unit configured to calculate the interpolation pixel value for interpolating a pixel value from the first charge holding portion based on pixel values of pixels surrounding the pixel in a case in which a defect is present in the first charge holding portion of the predetermined pixel.

9. The imaging apparatus according to claim 8, wherein the defective pixel correction unit is configured to calculate the interpolation pixel value for interpolating the pixel value from the first charge holding portion based on a pixel value output from the second charge holding portion of the pixel and pixel values of pixels surrounding the predetermined pixel in a case in which a defect is present in the first charge holding portion of the predetermined pixel.

10. The imaging apparatus according to claim 8, wherein the calculation unit is configured not to use pixel values equal to or greater than a predetermined value among the pixel values of the surrounding pixels for calculation of the interpolation pixel value.

11. The imaging apparatus according to claim 8, wherein operation of the calculation unit is controlled according to at least one of a type of the defect, a condition of a subject, and an imaging condition.

12. An imaging apparatus comprising:
an imaging element having a plurality of pixels each including a first photoelectric conversion unit, a second photoelectric conversion unit, a first charge holding portion configured to hold outputs from the first photoelectric conversion unit and the second photoelectric conversion unit, respectively, and a second charge holding portion configured to hold outputs from the first photoelectric conversion unit and the second photoelectric conversion unit, respectively, and
at least one processor or circuit configured to function as:
a defective pixel correction unit configured to calculate an interpolation pixel value for interpolating a pixel value from the first charge holding portion for holding output of the first photoelectric conversion unit based on a pixel value output from the first charge holding portion for holding output of the second photoelectric conversion unit of the pixel in a case in which a defect is present in the first charge holding portion for holding output of the first photoelectric conversion unit of a predetermined pixel.

13. A processing method comprising:
processing a signal from an imaging element having a plurality of pixels each including a photoelectric conversion unit, a first charge holding portion for holding an output of the photoelectric conversion unit, and a second charge holding portion for holding an output of the photoelectric conversion unit,
wherein in a case in which a defect is present in the first charge holding portion of a predetermined pixel, an interpolation pixel value for interpolating a pixel value from the first charge holding portion is calculated based on a pixel value output from the second charge holding portion of the pixel.

14. A non-transitory computer-readable storage medium storing a computer program to control an imaging element having a plurality of pixels each including a photoelectric conversion unit, a first charge holding portion for holding an output of the photoelectric conversion unit, and a second charge holding portion for holding an output of the photoelectric conversion unit,
wherein the computer program comprises instructions for executing following process:
calculating an interpolation pixel value for interpolating a pixel value from the first charge holding portion based on a pixel value output from the second charge holding portion of the pixel in a case in which a defect is present in the first charge holding portion of a predetermined pixel.
